(19) United States
(12) Patent Application Publication
(10) Pub. No.: US 2025/0305595 A1
(43) Pub. Date: Oct. 2, 2025

(54) FLUID CONTROL DEVICE, FLUID CONTROL SYSTEM, AND VALVE CONTROL DEVICE

(71) Applicant: FUJIKIN INCORPORATED, Osaka (JP)

(72) Inventors: Katsuyuki SUGITA, Osaka-shi (JP); Ryousuke DOHI, Osaka-shi (JP); Shinya OGAWA, Osaka-shi (JP); Toru HIRAI, Yokohama-shi (JP); Koji KAWADA, Yokohama-shi (JP)

(73) Assignee: FUJIKIN INCORPORATED, Osaka (JP)

(21) Appl. No.: 18/859,478

(22) PCT Filed: Mar. 28, 2023
(86) PCT No.: PCT/JP2023/012524

§ 371 Date: Jun. 18, 2025

(30) Foreign Application Priority Data
May 26, 2022 (JP) 2022-086441

(51) Int. Cl. F16K 37/00; F16K 31/02

(52) U.S. Cl. CPC F16K 37/0041; F16K 31/02

(57) ABSTRACT

The fluid control device 100 includes a valve control device 20 capable of communicating with an external device 30 and a valve 10 connected to the valve control device, and the valve control device 20 includes a valve driving circuit 22 for driving the valve, a digital communication circuit 26 connected to the valve driving circuit, and an input/output terminal 24 connected to the valve driving circuit, a digital communication circuit provided in the external device and the digital communication circuit 26 of the valve control device are configured to digitally communicate with each other, and a power supply and an analog communication circuit provided in the external device can be connected to the input/output terminal 24 of the valve control device by an integral cable C2 having at least four wires therein and connector AC, and power and analog signals are supplied from the external device via the input/output terminal 24.

### TECHNICAL FIELD

The present invention relates to a fluid control device, a fluid control system, and a valve control device, more particularly, to a valve control device capable of appropriately controlling a valve included in a flow rate control device provided in a semiconductor manufacturing facility, a chemical manufacturing device, a chemical plant, or the like, and a fluid control device and a fluid control system including the valve control device.

### BACKGROUND ART

Various types of flow meters, pressure gauges, and fluid control devices are used to control a fluid such as a source gas or an etching gas in a semiconductor manufacturing facility, a chemical manufacturing apparatus, a chemical plant, or the like. As a flow rate control device, a mass flow controller (thermal mass flow rate control device) and a pressure type flow rate control device are known.

The pressure type flow rate control device performs a flow rate control by controlling an upstream pressure of a restriction part by using a control valve and the restriction part (for example, an orifice plate or a critical nozzle). As the control valve, a piezo element driven valve configured to open and close a diaphragm valve element by a piezo actuator (hereinafter, sometimes referred to as a piezo valve) is used. The piezo valve can adjust the opening degree relatively precisely and can operate at a relatively high speed.

Further, the applicant of the present application has been developing a flow rate control device configured to fix a strain gauge to a piezo element of a piezo valve and detect a displacement amount of a diaphragm valve element or an operation member thereof based on an output of the strain gauge (for example, Patent Document 1). By adjusting the opening degree of the valve based on the displacement amount measurement, it is possible to perform flow rate control with higher responsiveness than the pressure type flow rate control device. Further, since the control valve is highly responsive as described above, the flow rate control can be more appropriately performed even when the control valve needs to be opened and closed frequently by a pulsed control signal in a process such as ALD (Atomic Layer Deposition) or ALE (Atomic Layer Etching).

### PRIOR-ART DOCUMENT

### Patent Document

[Patent Literature 1] International Patent Publication No. 2019/107215

[Patent Literature 2] International Patent Publication No. 2017/188129

### SUMMARY OF INVENTION

### Technical Problem

In the flow rate control device, the piezoelectric valve is driven by sending a control signal from an external device to a valve drive circuit (drive voltage output circuit to an actuator) connected to the valve. Conventionally, valve control is often performed using an analog signal, but in recent years, valve control by digital communication using a fieldbus system based on Ethernet or the like has become mainstream.

Patent Literature 2 discloses a fluid control device configured to perform valve control by EtherCAT (registered trademark) communication with an external device. In this fluid control device, a digital PWM (pulse-width modulation) signal is input to a valve driving circuit, and the valve driving circuit can apply a drive voltage corresponding to the duty cycle of the received PWM signal to the piezoelectric actuator by a step-up/step-down chopper type converter. By controlling the valve driving circuit using digital communication in this manner, it is possible to realize a reliable and high-speed valve control operation while suppressing noise.

However, in the conventional fluid control device using digital control as a mainstream as described above, when the digital communication is in an unconnected state or when a malfunction occurs in the digital communication, valve operation is not possible, and it is difficult to cope with a sudden failure occurrence and to control the valve in a more flexible manner.

In order to solve the above problem, an object of the present invention is to provide a valve control device capable of controlling a valve in a more flexible manner, and to provide a fluid control device and a fluid control system including the valve control device.

### Solution to Problem

A fluid control device according to an embodiment of the present invention includes a valve control device capable of communicating with an external device, and a valve connected to the valve control device, wherein the valve control device includes a valve driving circuit for driving the valve, a digital communication circuit connected to the valve driving circuit, and an input/output terminal connected to the valve driving circuit, wherein a digital communication circuit provided in the external device and the digital communication circuit of the valve control device are configured to be capable of digital communication, and a power supply and an analog communication circuit provided in the external device are connectable to the input/output terminal of the valve control device by an integral cable having a connection connector and having at least four wires therein, and power and an analog signal from the external device are supplied via the input/output terminal.

In an embodiment, the cable and the input/output terminal are connected via a D-sub connector.

In an embodiment, the valve is provided with a displacement sensor for measuring an opening degree of a valve element, and the valve driving circuit is configured to feedback control an actuator of the valve based on an output of the displacement sensor.

In an embodiment, the valve and the valve control device are provided separately and connected via a cable.

A fluid control system according to an embodiment of the present invention includes a plurality of fluid control devices, each of which is any of the fluid control devices described above, and a digital communication circuit of each valve control device of the plurality of fluid control devices is connected to the external device by an Ethernet-based fieldbus system, and an input/output terminal of each valve control device is connected to a power supply of the external device and an analog data communication circuit by an integral cable having at least four wires therein.

A valve control device according to an embodiment of the present invention is the valve control device included in any of the above described fluid control devices.

### Effect of Invention

According to an embodiment of the present invention, a valve control device, a fluid control device, and a fluid control system, in which both digital communication and analog communication can be used as communication with an external device, and a valve can be appropriately controlled in a more flexible manner, are provided.

### BRIEF DESCRIPTION OF DRAWINGS

FIG. 1 is diagram illustrating a fluid control device and a valve control device according to an embodiment of the present invention.

FIG. 2 is a sectional view illustrating a valve according to an embodiment of the present invention.

FIG. 3 is a plan view illustrating a valve control device according to an embodiment of the present invention, (a) shows a terminal arrangement surface, and (b) shows a side surface.

FIG. 4 illustrates an exemplary flow for determining whether to employ analog control or digital control.

FIG. 5 illustrates a fluid control system configured with a plurality of fluid control devices according to an embodiment of the present invention.

### DESCRIPTION OF EMBODIMENTS

Embodiments of the present invention will be described below with reference to the drawings, but the present invention is not limited to the following embodiments.

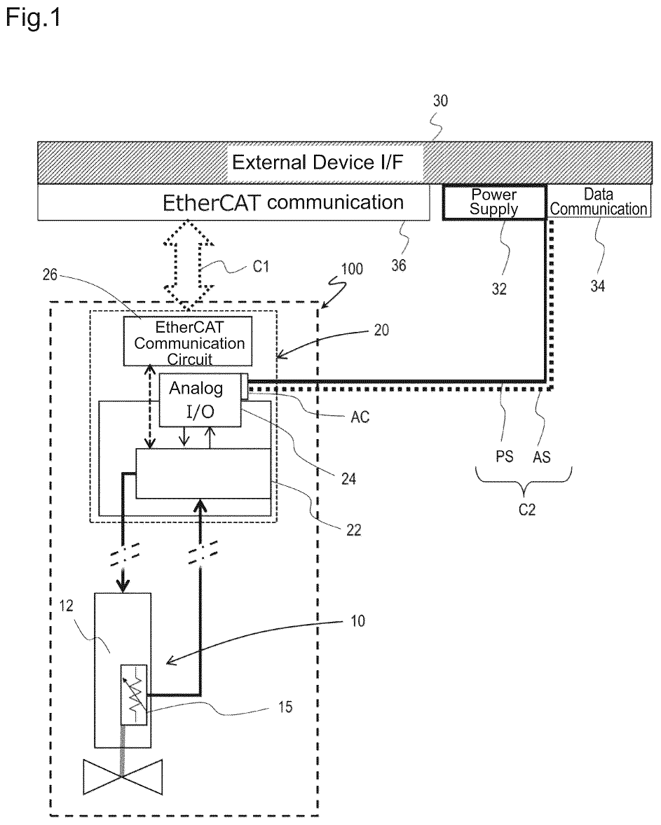

FIG. 1 shows a configuration of a fluid control device 100 according to an embodiment of the present invention. The fluid control device 100 includes a valve 10 disposed in a flow path and a valve control device 20 for controlling the operation of the valve 10. The valve control device 20 is communicably connected to an external device (information processing device) 30 and can control the driving of the valve 10 based on a command signal received from the external device 30. The external device 30 may be, for example, a general-purpose computer including a user input device.

The fluid control device 100 is used, for example in a semiconductor manufacturing apparatus, to control a flow rate of a gas (a source gas, an etching gas, or the like) from a gas source and supply the gas to a process chamber at a desired flow rate. The valve 10 is provided in a flow path of the fluid supply system, the upstream side of which is in communication with a fluid supply source, and the downstream side of which is in communication with a fluid use device such as a process chamber.

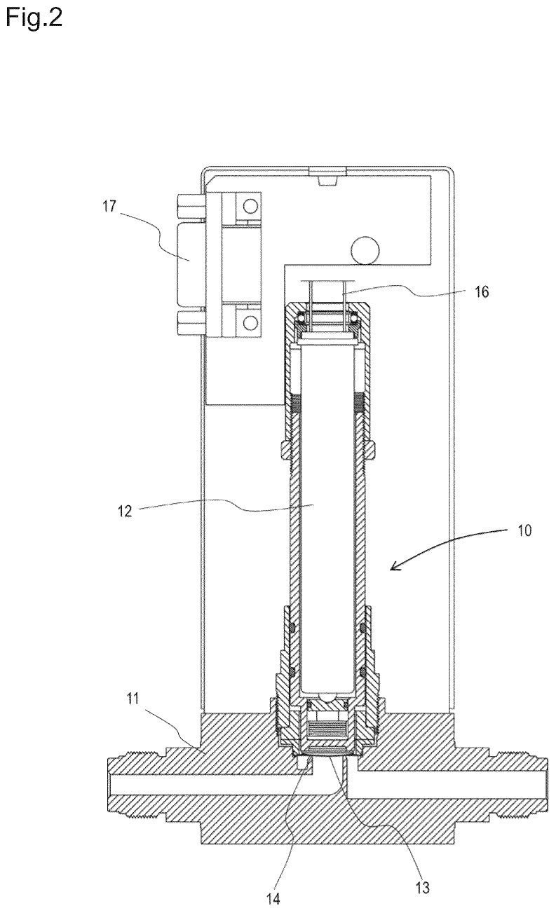

In the present embodiment, a piezoelectric element driven valve (piezo valve) as shown in FIG. 2 is used as the valve 10. The piezo valve is fixed to a flow path block 11 incorporated in the fluid supply system and is configured to be able to adjust the opening degree of a diaphragm 13 using a piezo actuator 12.

More specifically, the piezo actuator 12 is constituted by a plurality of stacked piezoelectric elements (not shown) or a single piezoelectric element housed in a cylindrical body. A voltage can be applied to the piezoelectric element via a wiring 16, and the element extends to a degree corresponding to the magnitude of the driving voltage. As a result, the extending degree of the piezoelectric element and thus the pressing force applied to the diaphragm valve element 13 by the piezoelectric actuator 12 against the valve seat 14 can be controlled, and the valve 10 can be opened to an arbitrary opening degree by controlling the driving voltage.

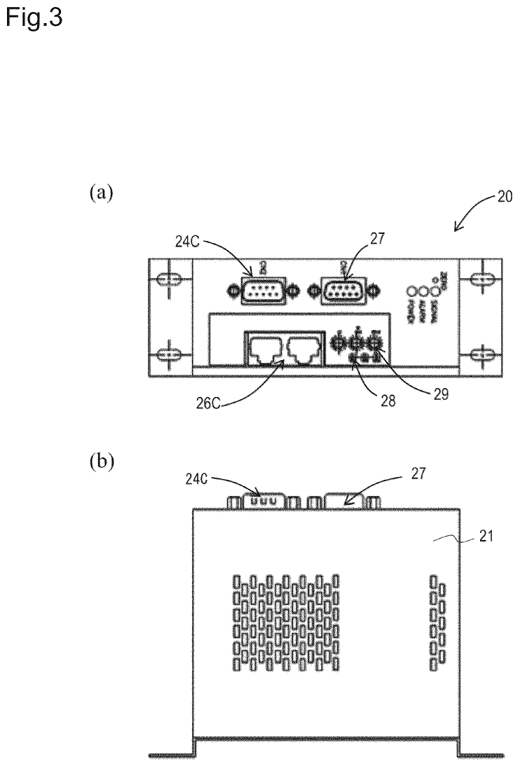

In the present embodiment, the valve 10 is provided separately from the valve control device 20 and is connected to each other by a cable. For this purpose, a connector 17 is provided on the housing surface of the valve 10, and similarly, as shown in FIG. 3, a connector 27 corresponding to the valve control device 20 is also provided. The number of Pin of the connector 17 is not particularly limited as long as it includes at least 4Pin for power supply and analog communication. In the present embodiment, a 9-pin D-sub (D-subminiature) connector is adopted.

By disposing the valve control device 20 away from the valve 10 in this manner, it is possible to place the valve control device 20 in a room temperature environment even when the valve 10 is placed in a high temperature environment, for example, in an application of flowing a high-temperature gas of 100° C. or higher. Therefore, in the valve control device 20, it is possible to prevent damage and operation of the control circuit due to heat. Further, in the case of the separation type, by adding a digital communication substrate to the conventional analog control device, it is easy to configure a hybrid digital-analog control device.

However, the present invention is not limited thereto, and in other embodiments, the valve 10 and the valve control device 20 may be provided close to each other. The valve 10 and the valve control device 20 may be housed inside a single casing or may be configured as a fluid control device 100 incorporating a control circuit board.

Referring again to FIG. 1, a displacement amount sensor 15 for measuring the opening degree of the valve element is provided in the valve 10. In the present embodiment, the displacement amount sensor 15 is configured by using a strain sensor fixed to a piezoelectric element. By using the strain sensor fixed to the piezo element to measure the opening and closing degree of the piezo valve, and performing feedback control based on the output thereof, it is possible to flow the fluid at a desired flow rate. The displacement amount sensor 15 is not limited to a strain sensor, and other sensors may be used. For example, as the displacement amount sensor 15, displacement sensor such as a capacitive type may be used (a sensor configured to measure the movement of the actuator moving portion as a change in capacitance).

A flow rate control method for driving a valve using such a displacement amount sensor is described in, for example, Patent Literature 1. Also in the present embodiment, by performing feedback control of the piezo valve based on the output of the displacement amount sensor 15, it is possible to flow the fluid to the downstream side of the valve at a set desired flow rate. Since this method can achieve higher responsiveness, the fluid control device 100 is also preferably used when pulsed flow rate control (or intermittent flow rate control) is required in an application such as ALD.

Although only the valve 10 including the displacement sensor 15 is shown in FIG. 1, similarly to the fluid supply system described in Patent Literature 1, the fluid supply system including the fluid control device 100 may further include another piezoelectric valve and restriction part connected in series to the upstream side of the valve 10, and a pressure sensor therebetween. In this case, intermittent flow rate control is performed by the valve 10 provided with the displacement amount sensor 15, on the other hand, when continuously flowing the gas at a constant flow rate for a relatively long time, it is possible to control the flow rate by adjusting the opening degree of the other valve based on the output of the pressure sensor. Further, by disposing another valve or a pressure sensor on the upstream side as described above, it is possible to control the pressure on the upstream side of the valve 10 to a desired value using the other valve, thereby enable change to the flow rate control range of the valve 10.

Hereinafter, a more detailed configuration of the valve control device 20 will be described. In the fluid control device 100 of the present embodiment, the valve control device 20 includes a valve driving circuit 22 for driving the valve 10. The valve driving circuit 22 is configured to be able to control the driving voltage applied to the piezo actuator based on the output of the displacement sensor 15. Further, the valve driving circuit 22 is configured by an analog circuit but is configured to be able to generate an arbitrary driving voltage to be applied to the piezo actuator based on digital data received from the outside and an output of the displacement sensor 15.

Since the valve driving circuit 22 is an analog circuit, it often has individual differences for each device. For this reason, the valve control device 20 may have individual information (flow rate correction information indicating a relationship between the given digital data and the actual valve opening degree (flow rate) according to the generated drive voltage, etc.) in a storage device such as a memory. The individual information may include a serial number, a flow rate control range, and, in a case where a pressure sensor is provided, temperature characteristic information thereof. Accordingly, when the valve control device 20 is replaced or the valve control device 20 is replaced with other system, the individual information can be read from the valve control device 20 and the flow rate control can be performed more appropriately.

Further, in the valve control device 20 of the present embodiment, an input/output terminal (or analog input/output) 24 and a digital communication circuit 26 are connected to the valve driving circuit 22. In this configuration, a valve control signal can be input to the valve driving circuit 22 from an external device (information processing apparatus) 30 via the input/output terminal 24 and the digital communication circuit 26 (or the digital input/output terminal) in dual systems.

On the other hand, the external device 30 generates digital data based on the designated set flow rate in the digital communication circuit, and outputs the digital data to the valve driving circuit 22 via the digital input/output terminal 36. In addition, the external device 30 can output an analog control signal to the valve driving circuit 22 via the analog communication terminal 34 as in the conventional manner.

In the present embodiment, the digital communication circuit 26 provided in the valve control device 20 is configured to perform communication with the digital communication circuit provided in the external device 30 by the Ethernet-based fieldbus system, more specifically, EtherCAT communication. In EtherCAT communication, a suitable LAN cable is used as the cable C1 to connect a digital input/output terminal 36 provided in the external device 30 to a digital input/output terminal 26C (see FIG. 3(a)) which is connected to the digital communication circuitry 26 of the valve control device 20.

However, the present invention is not limited to this, and various types of communication methods may be adopted as long as digital communication can be performed, and may be performed by DeviceNet (registered trademark) communication, RS485 communication, or the like. Of course, the valve control device 20 and the external device 30 are provided with corresponding digital communication circuits according to the communication method employed, and communication is performed using the corresponding cable and connector.

Here, the valve driving circuit 22 receives the set flow rate signal from the external device 30 via the digital communication circuit 26, compares the current flow rate and the set flow rate obtained from the output of the displacement sensor 15, and controls the drive voltage applied to the valve by feedback control so as to eliminate the difference. More specifically, in the same manner as the method described in Patent Literature 2, the valve driving circuit 22 can perform step-up/step-down of the piezoelectric actuator to match the set flow rate, by applying a PWM signal, of which duty cycle is adjusted to make the current flow rate and the set flow rate coincide, to the chopper type booster/step-down converter.

Further, in the present embodiment, the interface of the external device 30 is integrally provided with an analog communication terminal 34 for performing analog control and a power supply terminal 32 for performing power supply. The analogue communication terminal 34 and the power supply terminal 32 for performing power supply are constituted by, for example, 9-pin D-sub connector.

Similarly, the input/output terminal 24 provided in the valve control device 20 is also provided with a corresponding input/output terminal for receiving power and the analog control signal integrally. Between them are connected by an integral cable C2 having a corresponding connector AC (here, a 9-pin D-sub connector).

Here, the integral cable C2 includes two core wires for performing power supply (power supply line PS) and two core wires for performing analog data transmission (analog signal line AS). The integral cable C2 should include at least four cores. Thus, power can be supplied through the cable C2, and the valve driving circuitry 22 of the valve control device 20 can also be analog controlled from the external device 30.

When analog control is performed, a control signal is sent from the external device 30 to the input/output terminal 24 of the valve control device 20 using the cable C2, and digital data similar to digital communication converted by a A/D converter or the like provided therein is input to the valve driving circuit 22. As a result, the valve control equivalent to the control by the digital communication can be performed. In addition, when the valve driving circuit 22 outputs digital data indicating a flow rate or the like, the digital data may be transmitted to the external device 30 as an analog output by a D/A converter or the like connected to the input/output terminal 24.

In the present embodiment, the cable C2 also includes two core wires for transmitting analog data from the valve driving circuit 22 to the external device 30. Thus, six of 9-pin D-sub can be used to supply power to the valve control device 20 and to input and output signals to and from the valve driving circuit 22.

As the pin assignment when 9-pin D-sub is used, for example, pin numbers 1 and 2 are assigned to the signal input +(0 to 10V) and the signal input −(0V), pin numbers 4 and 5 are assigned to the signal output +(0 to 10V) and the signal output −(0V), and pin numbers 8 and 9 are assigned to the power supply +(DC 24V) and the power supply −(0V).

FIG. 3(a) and FIG. 3(b) show a terminal surface and a side surface of the valve control device 20 respectively. The terminal surface of the valve control device 20 is provided with a connector 24C for performing analog communication with the external device 30, a connector 27 for connecting with the valve 10, and a digital input/output terminal 26C for performing digital communication with the external device 30.

As shown in FIG. 3(a), in the valve control device 20 of the present embodiment, 9-pin D-sub connectors are used as the connector 24C and 27, and a RJ45 connector is used as the digital input/output terminal 26C. In addition, a rotary switch 29 for setting an address (ID), a pilot lamp 28 indicating a power-on state or a normal/abnormal state, and the like, are provided. Further, as shown in FIG. 3(b), the valve control device 20 is configured to house the valve driving circuit 22, the analog input/output, and the digital communication circuit 26 shown in FIG. 1 inside a box-shaped casing 21.

As described above, power supply from the external device 30 to the fluid control device 100 is not performed by a two-wire cable, but by using a cable having four or more wires therein and a corresponding connector, thus, it is also possible to perform the analog control of the fluid control device 100 using an extra core wire. In addition, by using a cable having six or more wires therein and a corresponding connector, it is also possible to monitor the output data from the fluid control device 100 in the external device 30.

Thus, for example, the fluid control device 100 can be operated by analog control even in a period in which digital communication is not connected after power-on, or in a case where there is a malfunction in digital communication. Therefore, it is possible to establish communication that is more resistant to failure, and it is possible to control the valve in a flexible communication mode.

Note that, in the above, the embodiment of using a 9-pin D-sub in cable for the connection with the external device 30 is described, needless to say, other connection modes may be adopted as long as the supply of power required by the fluid control device 100 (for example, DC 30V or less) and the analogue control of the fluid control device 100 can be performed. For example, connectors and cable of other D-sub standards (e.g., 15-pin D-sub or 25-pin D-sub) may be used. Alternatively, a half-pitch 20-pin connector and cable may also be used.

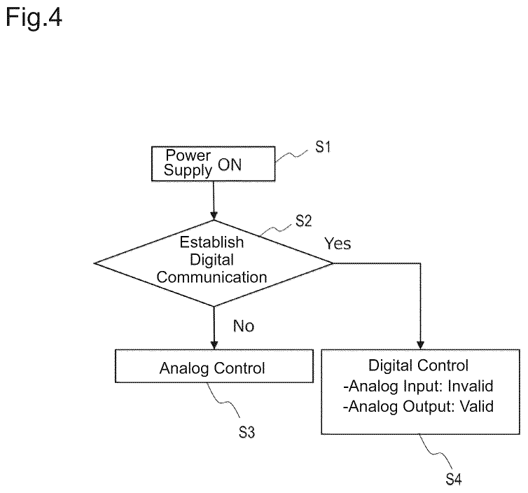

FIG. 4 illustrates an example flow for determining whether to employ digital control or analog control. As shown in step S1, when the power is turned on, it is then determined whether a digital communication has been established, as shown in step S2.

Here, the establishment of the digital communication is performed by, for example, setting of the external device 30. When no digital communication is established, analogue control is performed as a default-state in the present embodiment, as shown in step S3. On the other hand, when digital communication is established, digital control is performed as shown in step S4.

As described above, when the establishment of the digital communication is confirmed, the digital control is preferentially performed, so that the valve control by the digital communication which is the mainstream at present can be performed. However, when the digital communication is not established due to the occurrence of any abnormality or the user's designation, analog control can be performed supplementary.

Further, as shown in step S4, in the digital control, the digital control is performed without trouble by disabling the analog input, on the other hand, by enabling the analog output, it is also possible to use the output received by the external device 30 to analyze any failure or the like.

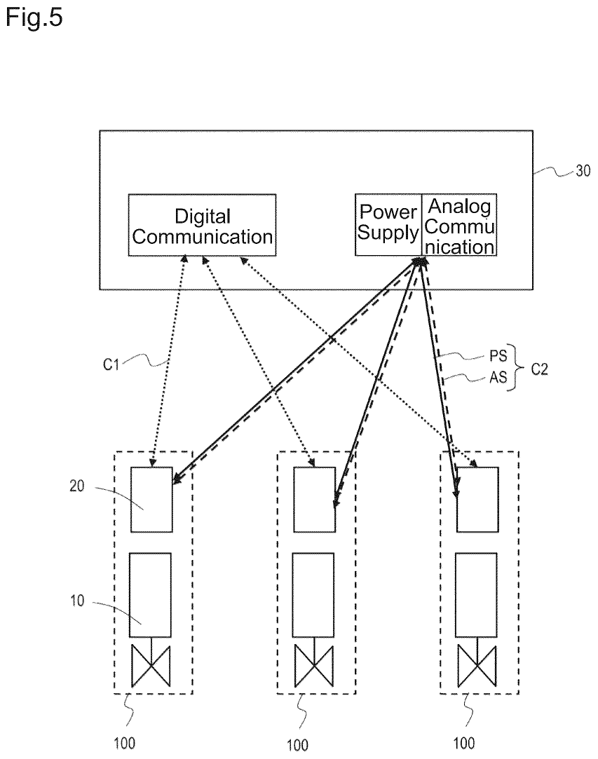

FIG. 5 is a diagram illustrating a configuration example of a fluid control system having a configuration in which a plurality of fluid control devices 100 are connected to a common external device 30. The fluid control device 100 is provided, for example, for each of a plurality of gas supply lines provided in the fluid supply system. These fluid control devices 100 can be collectively controlled by a common external device 30.

In the embodiment shown in FIG. 5, the digital communication circuit of the external device 30 and the valve control device 20 of the fluid-control devices 100 are connected by a cable C1. Similarly, the power supply circuit and the analogue communication circuit of the external device 30 are connected to the valve control device 20 of the respective fluid control device 100 by an integral cable C2 having four or more lines therein. In this way, the plurality of fluid control devices 100 can be flexibly controlled by digital control and analog control while being powered. When EtherCAT is adopted as the digital communication method, each of the fluid control devices 100 may be used as a slave, and the external device 30 may be connected to any one of the fluid control devices, and the remaining fluid control devices may be configured connecting as the slaves to each other.

### INDUSTRIAL APPLICABILITY

The fluid control device according to the embodiment of the present invention is preferably used, for example, for controlling a flow rate of gas by being connected to a gas supply line of semiconductor manufacturing.

### REFERENCE SIGNS LIST

10 Valve
11 Flow path block
12 Piezo actuator
13 Diaphragm valve element
14 Valve seat
15 Displacement sensor
17 Connector
20 Valve control device
22 Valve driving circuit
24 Input/output terminal
26 Digital communication circuit
30 External device
C1 Cable (Digital communication)
C2 Cable (Power, analog communication)
PS Power supply line
AS Analog signal line
100 Fluid control device

1. A fluid control device comprising a valve control device capable of communicating with an external device and a valve connected to the valve control device, the valve control device comprising:
a valve driving circuit for driving the valve;
a digital communication circuit connected to the valve driving circuit; and
an input/output terminal connected to the valve driving circuit;
wherein a digital communication circuit provided in the external device and the digital communication circuit of the valve control device is configured to be capable of digital communication; and
a power supply and an analog communication circuit provided in the external device are configured to be connectable to the input/output terminal of the valve control device by an integral cable having at least four wires therein and a connector, and to supply power and an analog signal from the external device via the input/output terminal.

2. The fluid control device according to claim 1, wherein the cable and the input/output terminal are connected by a D-sub connector.

3. The fluid control device according to claim 1 or 2, wherein the valve is provided with a displacement sensor for measuring an opening degree of a valve element, and the valve driving circuit is configured to feedback control an actuator of the valve based on an output of the displacement sensor.

4. The fluid control device according to claim 1 or 2, wherein the valve and the valve control device are provided separately and connected via a cable.

5. A fluid control system comprising a plurality of fluid control devices, each of which is the fluid control device according to claim 1 or 2,
wherein the digital communication circuit of the valve control device of each of the plurality of fluid control devices is connected by Ethernet based fieldbus system to the external device, and the input/output terminal of each valve control device is connected to the power supply and the analog data communication circuit of the external device by the integral cable having at least 4 wires therein.

6. The valve control device of the fluid control device according to claim 1 or 2.
